(19) United States
(12) Patent Application Publication
(10) Pub. No.: US 2015/0178866 A1
(43) Pub. Date: Jun. 25, 2015

(54) METHOD AND SYSTEM FOR AGGREGATING AND ANALYZING BUILDING PERMITS

(71) Applicant: Corelogic Solutions, LLC, Irvine, CA (US)

(72) Inventor: Dianna Serio, Irvine, CA (US)

(21) Appl. No.: 14/472,660

(22) Filed: Aug. 29, 2014

Related U.S. Application Data
(60) Provisional application No. 61/920,245, filed on Dec. 23, 2013.

(51) Int. Cl. G06Q 50/16; G06Q 10/00

(52) U.S. Cl. CPC G06Q 50/163; G06Q 10/00

(57) ABSTRACT

Computer-based systems and methods are disclosed for performing building permits analytics for real estate properties. Building permits data from multiple jurisdictions are collected, standardized, and stored. The collected building permits data is then used to perform one or more building permits analytics. In some embodiments, the systems and methods can improve rating/ranking of regions and contractors, detect sales leads, and detect potential fraud by considering building permits analytics. In some embodiments, the systems and methods can improve valuations of real estate properties, processing of insurance claims, and synchronization with external systems by considering building permits analytics.

### CROSS-REFERENCE TO RELATED APPLICATIONS

The present application claims the benefit of the earlier filing date of commonly owned U.S. Provisional Patent Application 61/920,245, filed on Dec. 23, 2013, the contents of which are hereby incorporated by reference in their entirety.

### BACKGROUND

1. Field

The present disclosure relates to computer processes for aggregating and analyzing building permits associated with a real estate property.

2. Description of the Related Art

Several market sectors may have an interest in data for specific building permits. Building permits are generally required for structural, electrical, air conditioning, and plumbing changes to a real estate property for work that could affect the public's health or safety if improperly performed. Entities such as banks, insurance companies, real estate agents, government agencies, vendors, investors, and utility providers may need building permits specific data. For example, investors may need a building permits data to validate that a property is in compliance with city codes. As another example, a government agency may need to know whether a property should be fined for violation of city ordinances. Because of the wide range of sources of information for building permits, it may be difficult for companies to locate information for a particular property without consulting several sources of data.

### BRIEF DESCRIPTION OF THE DRAWINGS

Throughout the drawings, reference numbers may be re-used to indicate correspondence between referenced elements. The drawings are provided to illustrate example embodiments described herein and are not intended to limit the scope of the disclosure.

FIG. 1 is a block diagram that schematically illustrates an example of a system to perform building permits analytics.

FIG. 2A is a block diagram that schematically illustrates an example of one or more attributes associated with building permits that may be collected in accordance with an embodiment.

FIG. 2B is a flowchart that illustrates an example of a method for processing acquired building permits data in accordance with an embodiment.

FIG. 3 is a block diagram that schematically illustrates an example of one or more modules that may be included in a system to perform building permits analytics in accordance with an embodiment.

FIG. 4 is a flowchart that illustrates an example of a method for determining a rating/ranking based on building permits data in accordance with an embodiment.

FIG. 5 is a flowchart that illustrates an example of a method for determining a rating/ranking of a region based on building permits data in accordance with an embodiment.

FIG. 6 is a flowchart that illustrates an example of a method for determining a sales lead based on building permits data in accordance with an embodiment.

FIG. 7 is a flowchart that illustrates an example of another method for determining sales leads based on building permits data in accordance with an embodiment.

FIG. 8 is a flowchart that illustrates an example of a method for detecting fraud based on building permits data in accordance with an embodiment.

FIG. 9 is a flowchart that illustrates another example of a method for detecting fraud based on building permits data in accordance with an embodiment.

FIG. 10 is a flowchart that illustrates an example of a method for detecting fraud for valuations based on building permits data in accordance with an embodiment.

FIG. 11 is a flowchart that illustrates an example of a method for processing insurance claims based on building permits data in accordance with an embodiment.

FIG. 12 is a flowchart illustrating an example of a method for determining valuations for real estate properties using building permits data.

FIG. 13 is a flowchart illustrating an example of a method for synchronizing external systems based on building permits data in accordance with an embodiment.

FIG. 14 is a flowchart that illustrates an example of a method for determining a rating/ranking based on building permits data and insurance data in accordance with an embodiment.

FIG. 15 is a flowchart that illustrates an example of a method for determining a profit margin based on building permits data and insurance data in accordance with an embodiment.

FIG. 16 is a flowchart that illustrates an example of a method for determining market statistics based on building permits data in accordance with an embodiment.

### DETAILED DESCRIPTION

Various aspects of the disclosure will now be described with regard to certain examples and embodiments, which are intended to illustrate but not to limit the disclosure.

Computer-based systems and methods are disclosed for performing building permits analytics for real estate properties. Building permits data from multiple jurisdictions are collected, standardized, and stored. The collected building permits data is then used to perform one or more building permits analytics. In some embodiments, the systems and methods can improve rating/ranking of regions and contractors, detect sales leads, and detect potential fraud by considering building permits analytics. In some embodiments, the systems and methods can improve valuations of real estate properties, processing of insurance claims, and synchronization with external systems by considering building permits analytics.

Implementations of the disclosed systems and methods will be described in the context of performing building permits analytics for real estate properties. This is for purposes of illustration and is not a limitation. For example, implementations of the disclosed systems and methods can be used to perform building permits analytics for commercial property developments, such as office complexes, industrial or warehouse complexes, retail and shopping centers, and apartment rental complexes.

### Example Real Estate OA Analytics System

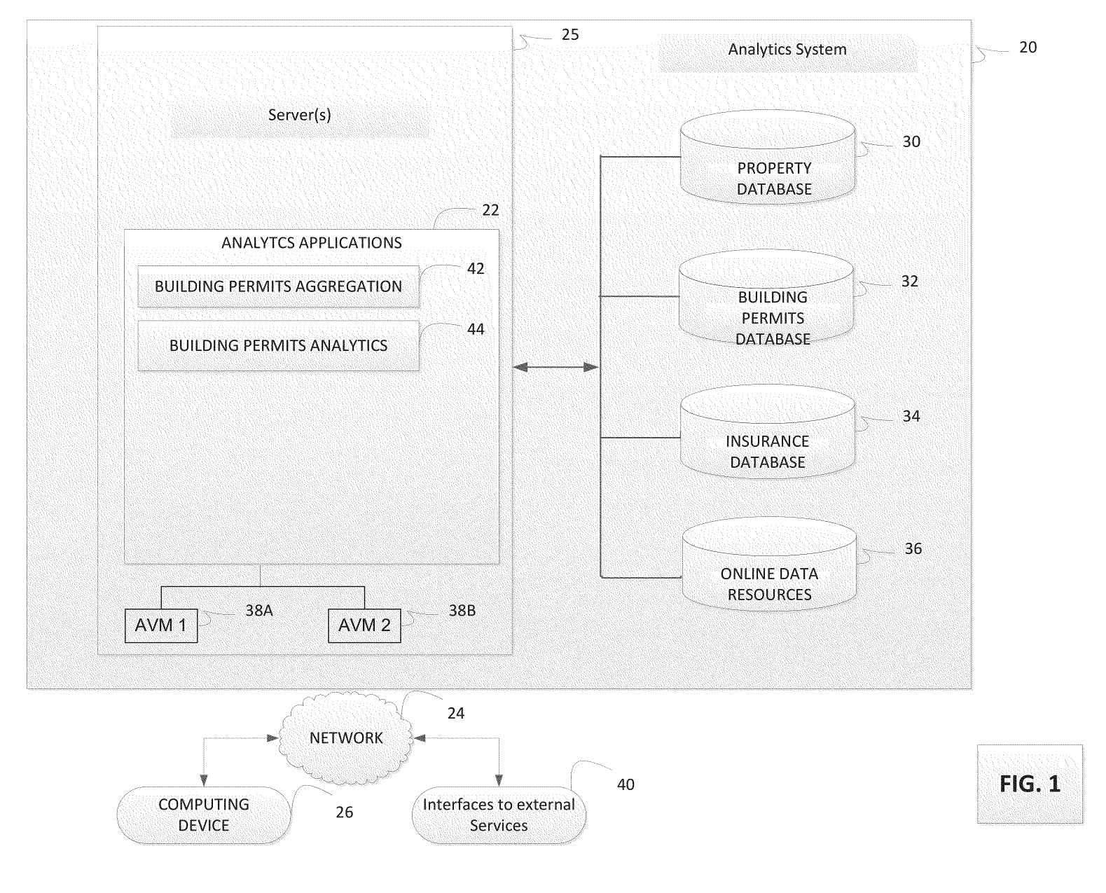

FIG. 1 illustrates an analytics system 20 according to one embodiment. The system may be provided by a business entity or “analytics provider” that provides various services to its customers for assessing investment opportunities and financial risks associated with real estate properties. As illustrated, the analytics system 20 includes a set of analytics applications 22 that are accessible over a network 24 (such as the Internet) via a computing device 26 (desktop computers, mobile phones, servers, etc.). Typical customers of the analytics system 20 include mortgage lenders, other types of lenders, mortgage and default servicers, real estate investors, real estate brokers, vendors, construction companies, and real estate appraisers.

As illustrated, analytics applications 22 use a set of data repositories 30-36 to perform various types of analytics tasks, including tasks associated with aggregating and analyzing building permits data. In the illustrated embodiment, these data repositories 30-36 include a database of property data, property database 30, a database of building permits data, building permits database 32, a database of insurance data, insurance database 34, and any other online data resources 36. Although depicted as separate databases, some of these data repositories 30-36 may be merged into a single database or distributed across multiple distinct databases. Further, additional databases containing other types of information may be maintained and used by the analytics applications 22. As shown in FIG. 1, each analytic application 22 runs on one or more physical servers 25 or other computing devices.

The property database 30 contains property data obtained from one or more of the entities that include property data associated with real estate properties. This data may include the type of property (single family home, condo, etc.), the sale price, and some characteristics that describe the property (beds, baths, square feet, etc.). These types of data sources can be found online. For example, multiple listing services (MLS) contain data intended for realtors, and can be contacted and queried through a network such as the Internet. Such data may then be downloaded for use by embodiments of the present invention. Other examples include retrieving data from databases/websites such as Redfin, Zillow, etc. that allow users to directly post about available properties. Furthermore, property database 30 may contain aggregated data collected from public records offices in various counties throughout the United States. This database 30 can include property ownership information and sales transaction histories with buyer and seller names, obtained from recorded land records (grant deeds, trust deeds, mortgages, other liens, etc.). In one embodiment, the analytics provider maintains this database 30 by purchasing or otherwise obtaining public record documents from most or all of the counties in the United States (from the respective public recorders offices), and by converting those documents (or data obtained from such documents) to a standard format. Such a database is maintained by CoreLogic, Inc. The property database 30 is preferably updated on a daily or near-daily basis so that it closely reflects the current ownership statuses of properties throughout the United States. In one implementation, the database 30 covers 97% of the sales transactions from over 2,535 counties.

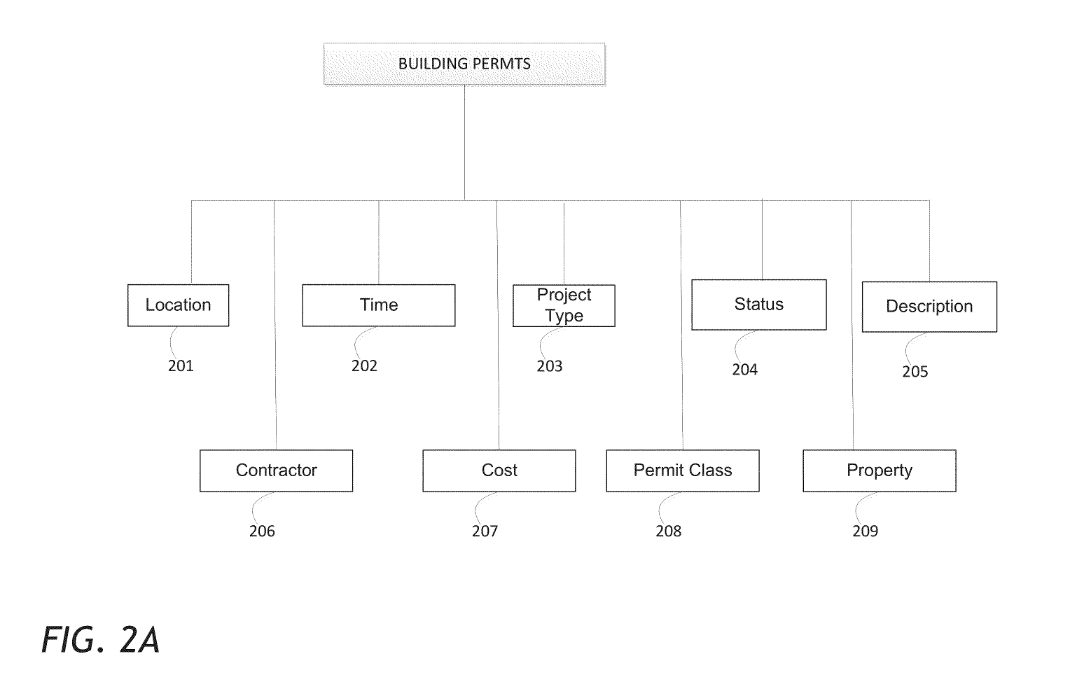

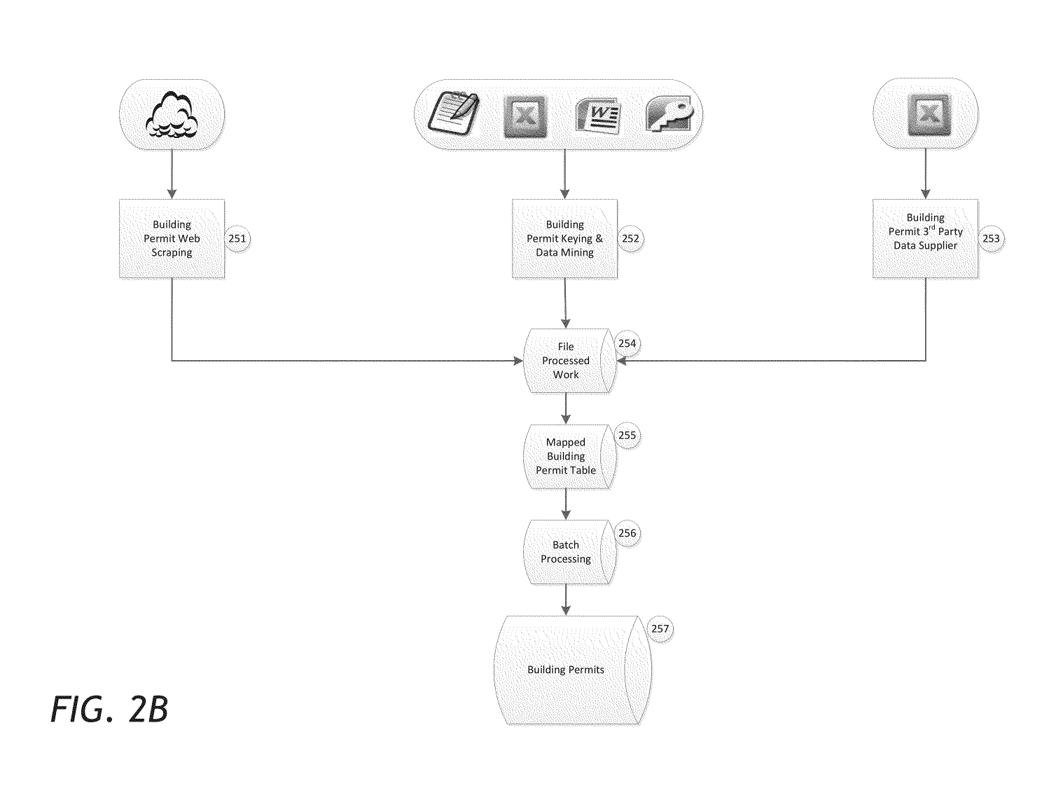

The building permits database 30 contains building permits data obtained from one or more of the entities that include building permits data associated with real estate properties. As illustrated in FIG. 2A, this data may include the location 201 of the real estate properties, time 202 of the adjustments made associated with the building permits, the project type 203 (e.g., addition, replacement, patio/deck, pool, electrical, mechanical, painting, solar, landscaping, etc.), permit status 204 (e.g., open, closed, issued, expired, etc.), project description 205, contractor 206 for project, cost 207, permit class 208 (e.g., residential, commercial, industrial, school, hazardous material, solar, etc.), or property 209 (e.g., single family residence, condominium, commercial, apartment, retail, warehouse, agricultural, etc.). These types of data sources can be found online. For example, government agencies may contain such data and can be contacted and queried through a network such as the Internet. Such data may then be downloaded for use by embodiments of the present invention. Furthermore, building permits database 32 may contain aggregated data collected from government offices in various counties throughout the United States. In one embodiment, the analytics provider maintains this database 32 by purchasing or otherwise obtaining building permits documents from most or all of the counties in the United States (from the respective building permits offices), and by converting those documents (or data obtained from such documents) to a standard format. Such a database is maintained by CoreLogic, Inc. The building permits database 32 is preferably updated on a daily or near-daily basis so that it closely reflects the current building permits statuses of properties throughout the United States.

For example, FIG. 2B illustrates one example of processing obtained building permits data. As shown, building permits data can be obtained from web scraping 251, keying and data mining 252, and/or a third-party data supplier 253. For web scraping, in some embodiments, on a periodic basis, websites associated with counties may be accessed to obtain building permits information. For data mining and keying, on a periodic basis in some embodiments, building permits data may be identified in county reports, downloaded files from county websites, subscription services, etc. and entered into building permits database 30. For third-party vendor data, building permits data may be periodically obtained from the vendor (e.g., Home Builders Weekly) and stored in building permits database 30. In some embodiments, prior to storage in the building permits database 30, the obtained data may be standardized. As illustrated, the obtained data may be placed in a temporary file 254 and then mapped into a common structure 255 for storage in the database. For instance, the fields of the acquired data may be mapped to the example structure of FIG. 2A. Subsequently, in some embodiments, the three sources can be merged into a batching database 256. In one embodiment, a backup of the batch being processed can be created so a copy of the pre-standardized data can be accessed if needed in original form. Address standardization may take place on various fields, such as the property address, applicant and contractor addresses. Address and other field matching may be performed to provide linkage to other datasets, such as tax roll data. Furthermore, in some embodiments, universal permit codes may be assigned based on text scans through the collected descriptive fields of the building permits. Finally, the resulting processed data may be stored in the building permits database 257.

The insurance database 34 contains insurance data obtained from one or more of the entities that include insurance data associated with real estate properties. Insurance data can include insurance policies, insurance claims, insurance payment data, insurance fraud data, etc. These types of data sources can be found online. For example, insurance companies may contain such data and can be contacted and queried through a network such as the Internet. Such data may then be downloaded for use by embodiments of the present invention. In one embodiment, the analytics provider maintains this database 36 by purchasing or otherwise obtaining insurance documents from most or all of the insurance companies in the United States (from the respective offices), and by converting those documents (or data obtained from such documents) to a standard format.

Online data resources 36 include any other online resources that provide available building permits data for real estate properties. Examples of online data resources 36 containing building permits data include servers owned, operated, or affiliated with, RealtyTrac Holdings, LLC, BuildFax, LexisNexis, or any other server or service containing building permits data.

As further shown in FIG. 1, the analytics system 20 may also include one or more interfaces 40 to other (externally hosted) services and databases. For example, the system may include APIs or other interfaces for retrieving data from LexisNexis, BuildFax, particular real estate companies, government agencies, and other types of entities.

As further shown in FIG. 1, the analytics applications 22 include a “building permits aggregation” application or application component 42 (hereinafter “application 42”). As explained above, this application or component 42 uses some or all of the data sources described above to acquire building permits data from multiple entities. The building permits data is aggregated from multiple entities and stored in the building permits database 32 in a standard format.

The analytics applications 22 also include a “building permits analytics” application or application component 44 (hereinafter “application 44”). As explained below, this application or component 44 analyzes building permits data collected by application 42 to perform building permits analytics for a particular property or group of properties.

### Building Permits Analytics

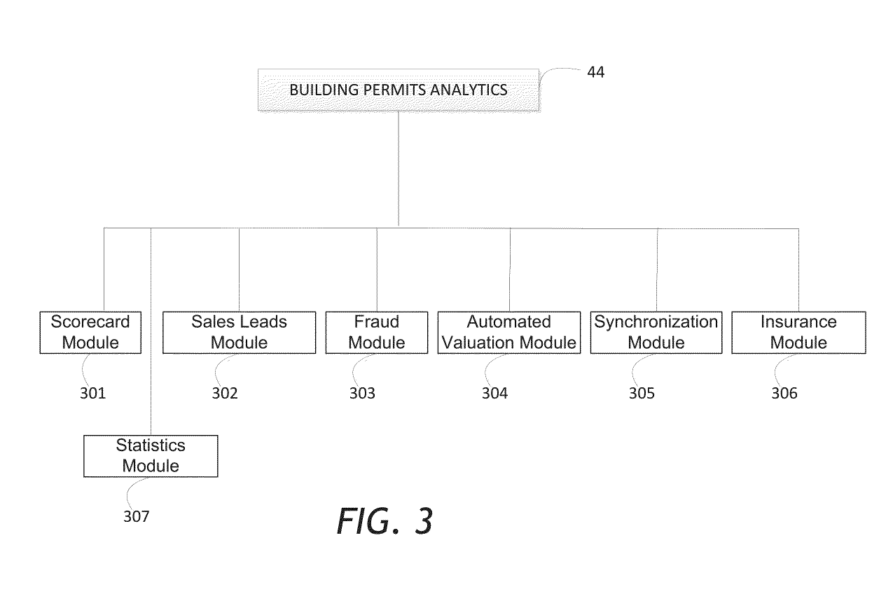

Application 44 may be configured to perform building permits analytics for a particular property or group of properties. In one embodiment, application 44 may be configured to implement one or more software modules to perform building permits analytics for a particular property or group of properties. For example, in some embodiments as shown in FIG. 3, the application 44 may be configured to implement a scorecard module 301, a sales leads module 302, a fraud module 303, an automated valuation module 304, a synchronization module 305, an insurance module 306, and a statistics module 307. Each of these example modules will be further explained below.

For example, in some embodiments, the scorecard module 301 is configured to determine a rating/ranking for a particular builder/contractor, property, or a group of properties. The ranking/rating can be used by interested parties, such as investors, financial institutions, etc. to determine how the building permits for a particular builder/contractor, property, or group of properties compare to building permits for other builders/contractors/properties. For instance, scorecard module 301 may communicate with application 42 to determine a number of building permits obtained by a builder to be ranked or rated. The scorecard module 301 then may compare the number of permits to a comparable builder or an aggregate number of permits (e.g., average, weighted average, etc.) to determine a ranking/rating for the particular builder. In some embodiments, a rating/ranking for a particular builder/contractor can be determined by the scorecard module 301 by considering a variety of other factors (as enumerated in FIG. 2A). For instance, the fees submitted in the building permits for landscaping by a particular builder may be compared to fees other builders submit for landscaping. As another example, the length of time between applying for a permit and issuance of the permit for a particular builder can be compared to other builders to determine a rating/ranking. As yet another example, a number of permits applied for but not issued by a contractor may be compared to other contractors in a particular zip code to determine a rating/ranking.

Similarly, rankings/ratings may be determined for a property of group of properties. For example, for a property being offered for sale, application 44 can determine which permits have been issued for that property and compare the issued permits with issued permits of comparable properties. As another example, building permits for a group of properties in a subdivision may be analyzed to determine what type of modifications have been made in the subdivision and compare the modifications to other subdivisions to determine a ranking/rating. As yet another example, building permits for a group of properties in a subdivision may be analyzed to determine fees spent on enhancements and compare the enhancements to other subdivisions to determine a ranking/rating. A combination of these factors among others may be considered in determination of the rankings/ratings by the scorecard module 301 using the processes discussed above. Comparable properties or the group of properties (e.g., subdivision) to be analyzed can be identified by accessing the property database 30.

In some embodiments, the rankings/ratings may be determined based on user preferences. For example, a user preference may indicate that a particular builder be ranked/rated against builders in the same zip code that have been in business for a similar number of years. The length of time that a builder has been in business can be determined by accessing building permits data 32 to determine the earliest date a building permit was applied for by the builder or by accessing other online data resources 36. The scorecard module 301 may then determine the rating/ranking based on the user preferences. Similar processing may be performed for ranking/rating properties or group of properties based on user preferences. For example, a user preference may include an indication that the particular property of interest only be compared to properties in the same city that were built around the same time. The user preferences then may be used to determine the rankings/ratings, as discussed above. Embodiments of the present invention are not limited to example rankings/ratings discussed above. A variety of other rankings/ratings could be determined by the scorecard module 301 in embodiments of the present invention. For example, the scorecard module 301 may determine a ranking/rating for a particular property by comparison to an aggregate building permit fees in a region associated with the particular property. As an example, the ranking/rating of a property could be determined by comparison to the mean building permit fees in the state associated with the particular property of interest. As another example, a rating/ranking for a subdivision may be based on a comparison of number/type of projects performed in the subdivision compared to the number/type of projects performed in comparable subdivisions.

Next, in some embodiments, the sales leads module 302 is configured to provide a notification of potential sales leads based on the building permits data 32. For example, application 44 may analyze the building permits data to identify building permits that were applied for but were not issued. These permits may indicate projects that had started but were not completed. In some embodiments, application 44 can focus the search on recent building permits (e.g., 1 year) to identify recent projects that had started but were not completed. Application 44 may then determine the type of projects from the identified building permits that have not been completed and identify vendors that may be interested in completing the projects. Application 44 then may provide the project and property information to the vendors as potential sales leads. The analytics provider may provide the potential sales leads for a fee. The list of vendors may be generated by locating contractors associated with similar projects in regions associated with the identified incomplete projects from the building permits data 32 or by accessing online data resources 36.

As another example, sales leads module 302 may analyze the building permits data to identify building permits for completed projects. As discussed above, application 44 may focus on recent building permits for projects. Then application 44 may identify supplementary services/products associated with the projects. For instance, for a completed landscaping project, application 44 may identify supplementary gardening, cleaning, water fountain, etc. services/products. As another example, for a completed room addition project, application 44 may identify supplementary electrical, painting, plumbing, etc. services. Subsequently, as discussed above, application 44 may identify a list of vendors for the supplementary services/products and notify the vendors of potential sails leads. The sales leads may be provided for a fee. The list of vendors, as discussed above, may be identified by accessing the building permits data 32 and online data resources 36.

The fraud module 303, in some embodiments, may be configured to detect potential fraud by validating transactions, insurance policies, insurance claims, etc. by accessing the building permits data 32. For example, marketing, advertising, or transactions information associated with pending sales offers for real estate properties may be collected by application 42. The listed features may then be compared to the building permits for those properties. Based on the comparison a fraud score/risk may be calculated. As an example, a short sale offer for a particular property may fail to indicate the addition of a room in the associated marketing information. The offer may exclude the room addition information in an attempt to obtain lower offers for the property which then may be resold by the buyer for a large profit. If the parties involved have existing relationships then the short sale may be fraudulent. Detecting fraudulent marketing information by comparing it to building permits data 32 may prevent these types of fraudulent transactions. As another example, a buyer may purchase a real estate property and subsequently attempt to resell the property for a profit. The buyer may offer to sell the property at a high price claiming significant remodeling has been done. A fraudulent appraisal may also be obtained that confirms that the property should be sold at the high price. However, comparing the resale offer and the alleged remodeling with the building permits data 32 may detect and prevent such fraudulent transactions and/or appraisals.

To determine a fraud risk/score, historical transactions that were found to be fraudulent may be analyzed by performing fraud analysis using the building permits data 32 as discussed above. The marketing or transaction information in comparison to the respective building permits of the fraudulent transactions then may be statistically analyzed to identify the fraud risk/score for the marketing or transaction information. Other variations for generating risk scores are possible in embodiments of the present invention.

The fraud module 303 may perform similar fraud analysis for insurance claims or policies. For example, a particular insurance policy may state that changes, modifications, additions, etc. for which building permits have not been obtained, are not covered by the insurance policy. As a result, any damage done or caused by or to the changes, modifications, additions, etc. may not be covered by the insurance policy and any claims may be denied. An insurance company may request the analytics provider to verify that building permits have been obtained for any items of interest related to a subject property.

Next, in some embodiments, the automated valuation module 304 may be configured to communicate with application 42 to identify building permits associated with a property to determine an automated valuation based at least in part on the identified building permits. An automated valuation model, such as a regression model, a neural network model, etc., may be generated using the identified building permits as an input along with any other desired inputs (e.g., property database 30) and an automated valuation as an output for the automated valuation model may be determined. For example, application 44 can communicate with AVM1 38A or AVM2 38B to determine an automated valuation for the particular property of group of properties. U.S. Pat. No. 5,361,201, which is hereby incorporated by reference in its entirety, describes various systems and methods for performing automated valuations of properties. Similarly, in some embodiments, an automated valuation for a property may be determined by the application of a valuation index, such as a Home Price Index (“HPI”) to historical prices and identified building permits associated with the property to determine the valuation of the property. In some embodiments, other types of valuations may be performed based on the identified building permits. For example, application 44 may provide the identified business permits for use in generation of an appraisal, a Broker Price Opinion (“BPO”), etc. In various embodiments, the automated valuation module may enable consumers to interactively communicate with the analytics provider to determine what effect on an automated valuation for a property a particular project may have. For example, a user may request to receive information on the effect on the valuation of his/her property based on adding a swimming pool. Application 44 can access comparable properties and identify any building permits associated with the comparable properties that are related to adding a swimming pool. Application 44 may then identify an automated valuation of the comparable properties prior to adding the pool and the automated valuations of the comparable properties after adding the pools. Then application 44 may determine an aggregate valuation impact (e.g., average, weighted average, etc.) of the swimming pool and provide the result to the requesting user. Similar analysis may be applied for any type of project.

The synchronization module 305, in some embodiments, may be configured to provide the collected business permits data 32 to third-party systems to ensure that most current building permits data is synchronized with the third-party systems. For example, application 44 may provide the collected business permits data 32 to MLS systems such that their systems including property descriptions can be synchronized with the collected building permits data. Other third party systems that may be provided the building permits data 32 include LPS, Redfin, Zillow, Trulia, etc. Providing such data may help ensure that accurate property data is maintained by these systems. The building permits data may be provided to third-party systems for a fee.

The insurance module 306, in some embodiments, may be configured to communicate with building permits data 32 and insurance data 34 to verify the building permits data by comparing the data to the insurance data. As discussed above, the insurance data 34 may include data related to the cost of rebuilding or repairing real estate properties. The cost for rebuilding or repairing the real estate properties may be compared to the fees submitted in the collected business permits data to determine the differences in the fees. The differences may be then used to determine the quality of a builder/contractor or the rate/rank of a builder/contractor. For example, application 44 may determine from the insurance data that it would cost $10,000 to build a swimming pool for a particular property that was destroyed. However, collected building permits for the particular property indicate that $15,000 was submitted as the fees. Based on this difference, a rating/ranking of the contractor that built the swimming pool can be determined. In some embodiments, insurance data may not be available for a particular property. However, insurance data from comparable properties may be used to predict what the insurance data for the particular property may be. Similar processing as discussed above in relation to calculating automated valuations may be performed.

In some embodiments, aggregate (e.g., average, weighted average, etc.) insurance data may be determined for a geographic region (e.g., zip code). The aggregate value may be calculated by project type, property type, time of year, contractor type, contractor, etc. The aggregate values then may be compared to the business permits data 32 of similar type to determine one or more metrics. For example the aggregate value to perform landscaping from the insurance data in a particular zip code may be compared to the aggregate building permits fees submitted for landscaping in the particular zip code. The difference, in some embodiments, may be used to calculate a profit index for landscaping in the particular zip code. That is, the building permit fees may be higher than the insurance fees to account for a profit. The profit index may then be stored or provided to interested parties. In various embodiments, the profit index may be used to calculate a standard deviation for the building permit fees. The output may also then be stored or provided to interested parties as desired. The calculated standard deviation can be used to predict the general profits for projects in a particular zip code and to rank/rate contractors by the amount of profit they include in the building permits. The output can also be used by predictive models (e.g., regression, neural networks, etc.) to predict what a particular project would cost or what a particular contractor may charge for a project. The predictions may be provided to interested parties, such as investors, to determine what a particular remodeling project may cost or which contractor they can afford. For example, an investor may request an analytics provider to provide an estimate of the cost of adding a retaining wall. Application 44 may identify the cost by using the predictive models based on the profit analysis described above. Application 44 can determine from the insurance data what the cost would be to build the retaining wall for the subject property. Application 44 may then determine a profit index for the region associated with the subject property and use the predictive models to calculate a predicted cost for building the retaining wall. Application 44 may also provide a ranked list of potential contractors for the project based on the profit analysis and calculated standard deviation. A variety of alternative analytics may be performed by embodiments of the present invention based on the insurance data 34 and building permits data 32.

The statistics module 307, in some embodiments, may be configured to provide statistics based on the building permits data 32. For example, application 44 may analyze the building permits data 32 to identify builders/contractors and to determine statistics, such as market share, efficiency, quality, specialty, etc. These permits may be analyzed to determine what percentage of projects in a certain geographic region are being managed by a particular builder/contractor, what percentage of a particular project type are being managed by a particular builder/contractor, what percentage of work for a particular builder/contractor relate to a certain project type, etc. In some embodiments, application 44 can analyze the building permits data 32 to identify aggregate trends in project types in a geographic area, project durations in a geographic area, locations for project activities, etc.

As another example, statistics module 307 may analyze the building permits data to identify building permits for particular project types. The identified building permits then may be analyzed relative to the aggregate building permits data to determine what percentage of projects relate to a project type, how long does a particular project type take relative to other projects, how much does a particular project cost relative to other projects, etc. Similar analysis may be performed for any field included in the building permits data 32 (e.g., FIG. 2A).

### Example Real Estate Property Rating Process

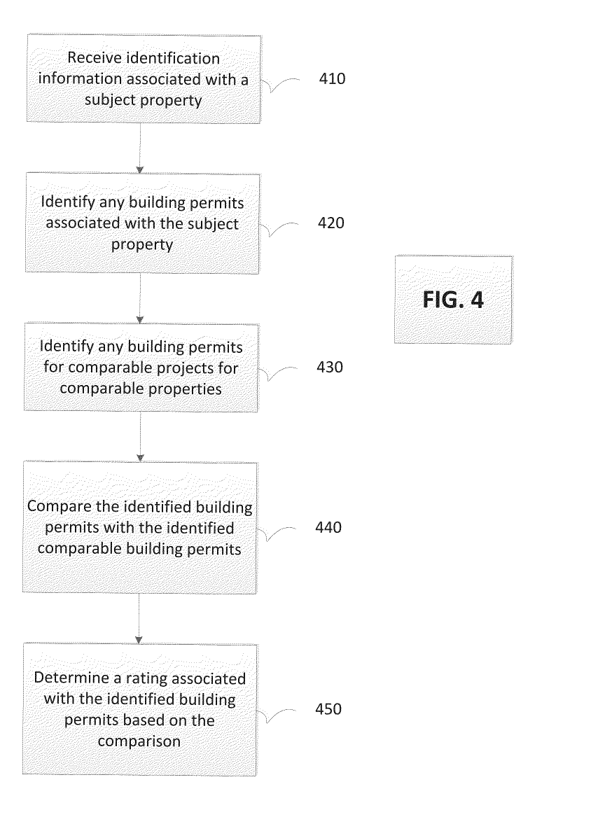

FIG. 4 illustrates one embodiment of an automated process that may be used by the analytics applications 22 to determine a rating/ranking for building permits associated with a property. As mentioned above, this process may be useful (as one example) for enabling an investor to decide whether to invest in a subject property.

As depicted by block 410 of FIG. 4, the application 44 initially receives identification information associated with a subject property (e.g., address, property owner identification, parcel number, etc.). Application 44 may communicate with computing device 26 to receive the identification information. The application 44 may then, in some embodiments, process the received identification information to uniquely identify the subject property of interest by, for example, communicating with data repositories 30-36 or any other data repository to map the received identification information to the subject property.

As shown in block 420 of FIG. 4, any building permits associated with the subject property are identified. As discussed above, application 44 may communicate with application 42 to identify any collected business permits data associated with the subject property.

As depicted by block 430 of FIG. 4, any business permits data associated with comparable properties for comparable projects are identified. As discussed above, the type of projects for the building permits associated with the subject property are identified and comparable projects for comparable properties are determined. Then application 44 may communicate with application 42 to identify any business permits for the comparable projects for the comparable properties.

Subsequently, as depicted by block 440 of FIG. 4, the building permits associated with the subject property are compared to the building permits for comparable projects for comparable properties. As discussed above, the comparison can be used to rate/rank the subject property based on how many permits have been obtained in comparison to other properties and/or how many upgrades have been made to the subject property. A comparison can also be made based on type of upgrades obtained in comparison to comparable properties.

As depicted by block 450 of FIG. 4, application 44 may determine a rating/ranking associated with the identified building permits associated with the subject property. Application 44 may determine the rating/ranking based on the comparison as discussed above. Application 44 may store or provide the ratings/rankings to interested parties, such as the computing device 26. As also discussed above, in some embodiments, the rankings/ratings may be determined based on user preferences.

### Example Group of Real Estate Properties Rating Process

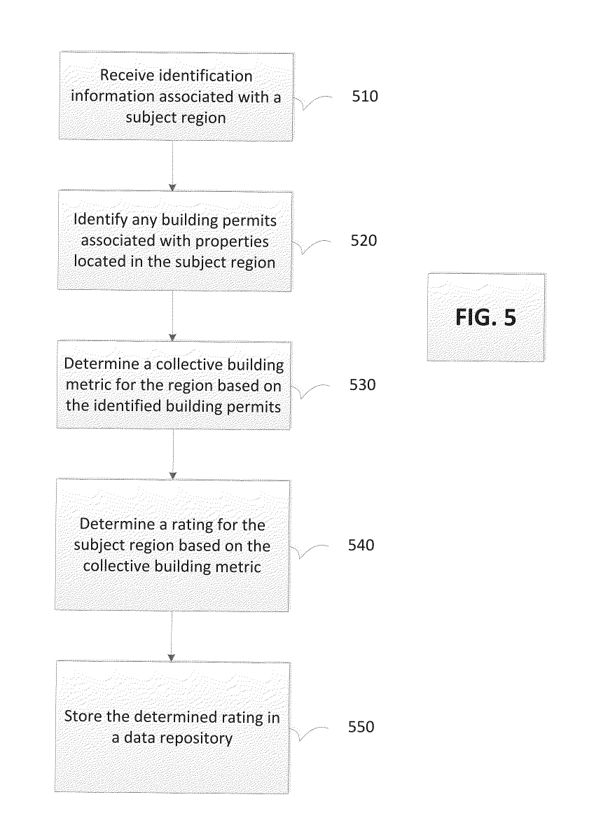

FIG. 5 illustrates one embodiment of an automated process that may be used by the analytics applications 22 to determine a rating/ranking for a group of properties.

As depicted by block 510 of FIG. 5, the application 44 initially receives identification information associated with a subject region (e.g., subdivision, zip code, city, county, etc.). Application 44 may communicate with computing device 26 to receive the identification information. The application 44 may then, in some embodiments, process the received identification information to uniquely identify the subject region of interest by, for example, communicating with data repositories 30-36 or any other data repository to map the received identification information to the subject region.

As shown in block 520 of FIG. 5, any building permits associated with the subject region are identified. As discussed above, application 44 may communicate with application 42 to identify any collected business permits data associated with the subject region.

As depicted by block 530 of FIG. 5, a collective building metric for the subject region may be calculated based on the identified building permits. As discussed above, the collective metric may include an aggregate measure associated with the subject region based on the identified building permits. For example, the collective metric may include an average or weighted average of fees submitted for the building permits by project type, by date, by property type, or any other desired dimension. As another example, the collective metric may include the average number of permits obtained per property in the subject region.

Subsequently, as depicted by block 540 of FIG. 5, a rating for the subject region may be determined based on the calculated collective metric. As discussed above, the calculated metric may be compared to other regions or comparable regions. The comparison then may be used to determine a rating/ranking for the subject region. For example, the average number of upgrades for a subdivision may be compared to the average number of upgrades for other subdivisions located in a particular county. Based on the comparison, a rating/ranking can be determined for the subject region.

As depicted by block 550 of FIG. 5, application 44 may store the calculated ratings/rankings in a data repository. The rating/ranking may be provided in one or more reports and/or provided to interested parties.

### Example Sales Lead Process

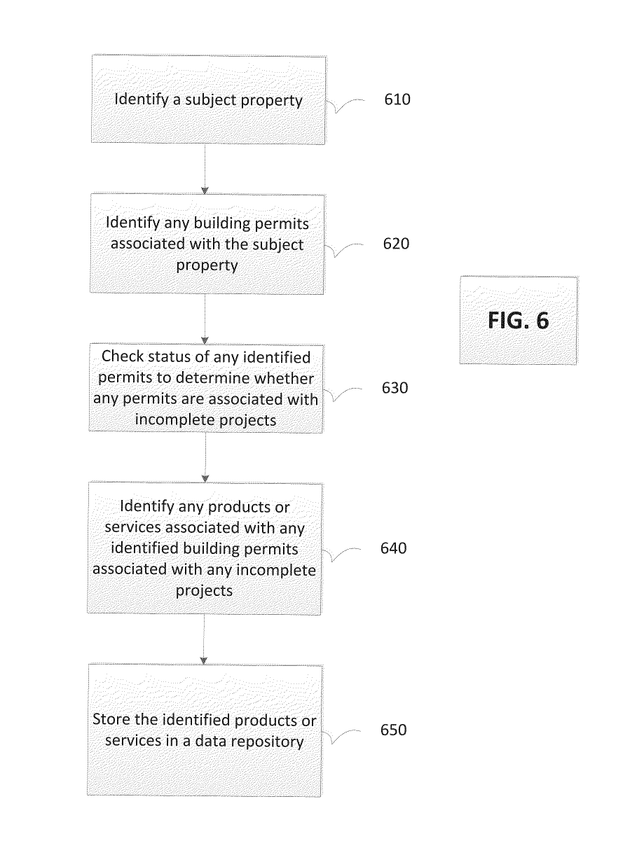

FIG. 6 illustrates one embodiment of an automated process that may be used by the analytics applications 22 to determine potential sales leads based on collected building permits data.

As depicted by block 610 of FIG. 6, the application 44 initially identifies a subject property. Application 44 may identify any property for which business permits have been collected.

As shown in block 620 of FIG. 6, any building permits associated with the subject property are identified. As discussed above, application 44 may communicate with application 42 to identify any collected business permits data associated with the subject property.

As depicted by block 630 of FIG. 6, the status of any identified building permits are checked to determine whether any of the permits are associated with incomplete projects. As discussed above, the business permits can be checked to see whether building permits that were applied for were actually issued. The business permits that have not issued are identified as being associated with incomplete projects.

Subsequently, as depicted by block 640 of FIG. 6, any products or services associated with the incomplete projects in the identified building permits are determined. As discussed above, for potential sales leads, any potential products and services that are associated with the incomplete projects are identified.

As depicted by block 650 of FIG. 6, application 44 may store the identified products or services in a data repository. As discussed above, the identified products or services may be provided to interested parties, such as vendors, as potential sales leads. In some embodiments, the potential sales leads may be provided for a fee.

### Example Alternate Sales Lead Process

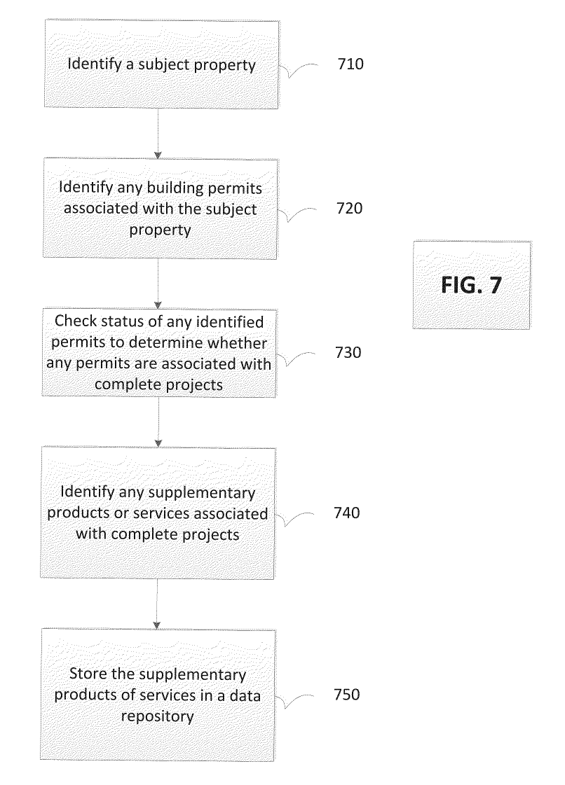

FIG. 7 illustrates one embodiment of an automated process that may be used by the analytics applications 22 to determine potential sales leads based on collected building permits data.

As depicted by block 710 of FIG. 7, the application 44 initially identifies a subject property. Application 44 may identify any property for which business permits have been collected.

As shown in block 720 of FIG. 7, any building permits associated with the subject property are identified. As discussed above, application 44 may communicate with application 42 to identify any collected business permits data associated with the subject property.

As depicted by block 730 of FIG. 7, the status of any identified building permits are checked to determine whether any of the permits are associated with complete projects. As discussed above, the business permits can be checked to see whether building permits that were applied for were actually issued. The business permits that have issued are identified.

Subsequently, as depicted by block 740 of FIG. 7, any supplementary products or services associated with the completed projects in the identified building permits are determined. As discussed above, for potential sales leads, any potential supplemental products and services that are associated with the completed projects are identified.

As depicted by block 750 of FIG. 7, application 44 may store the identified supplementary products or services in a data repository. As discussed above, the identified supplementary products or services may be provided to interested parties, such as vendors, as potential sales leads. In some embodiments, the potential sales leads may be provided for a fee.

### Example Real Estate Fraud Detection Process

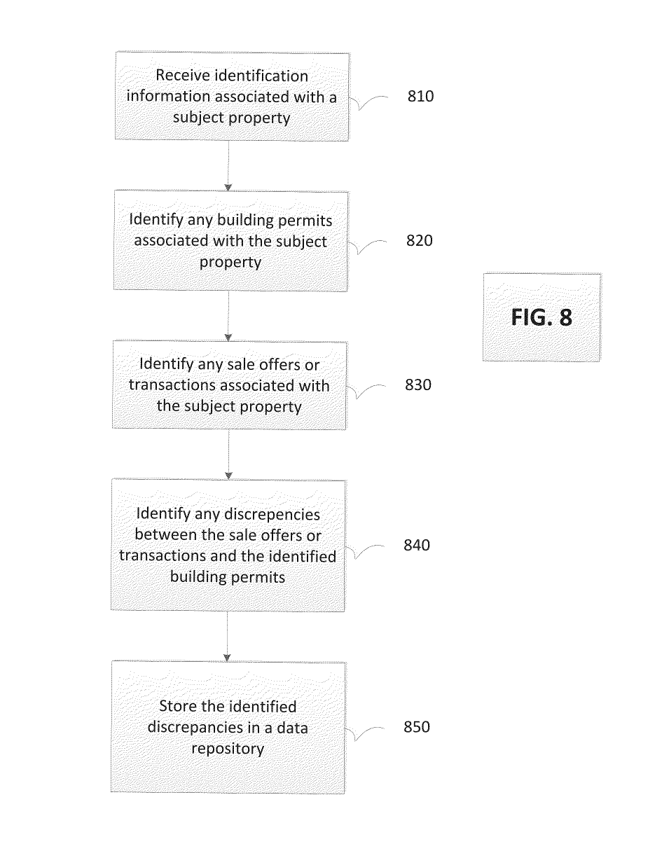

FIG. 8 illustrates one embodiment of an automated process that may be used by the analytics applications 22 to detect potential fraud based on the collected business permits data.

As depicted by block 810 of FIG. 8, the application 44 initially receives identification information associated with a subject property (e.g., address, property owner identification, parcel number, etc.). Application 44 may communicate with computing device 26 to receive the identification information. The application 44 may then, in some embodiments, process the received identification information to uniquely identify the subject property of interest by, for example, communicating with data repositories 30-36 or any other data repository to map the received identification information to the subject property.

As shown in block 820 of FIG. 8, any building permits associated with the subject property are identified. As discussed above, application 44 may communicate with application 42 to identify any collected business permits data associated with the subject property.

As depicted by block 830 of FIG. 8, any sale offers or transactions associated with the identified subject property are identified. As discussed above, online data resources may be accessed to identify any sale offers or transactions associated with the subject property.

Subsequently, as depicted by block 840 of FIG. 8, any discrepancies between the identified sale offers or transactions and the collected business permits data associated with the subject property are identified. As discussed above, information associated with the sale offers or transactions may be compared to the business permits data to identify any discrepancies.

As depicted by block 850 of FIG. 8, application 44 may store the identified discrepancies in a data repository. The discrepancies may be provided in one or more reports and/or provided to interested parties. In some embodiments, a risk or fraud score may be calculated as discussed above.

### Example Alternate Real Estate Fraud Detection Process

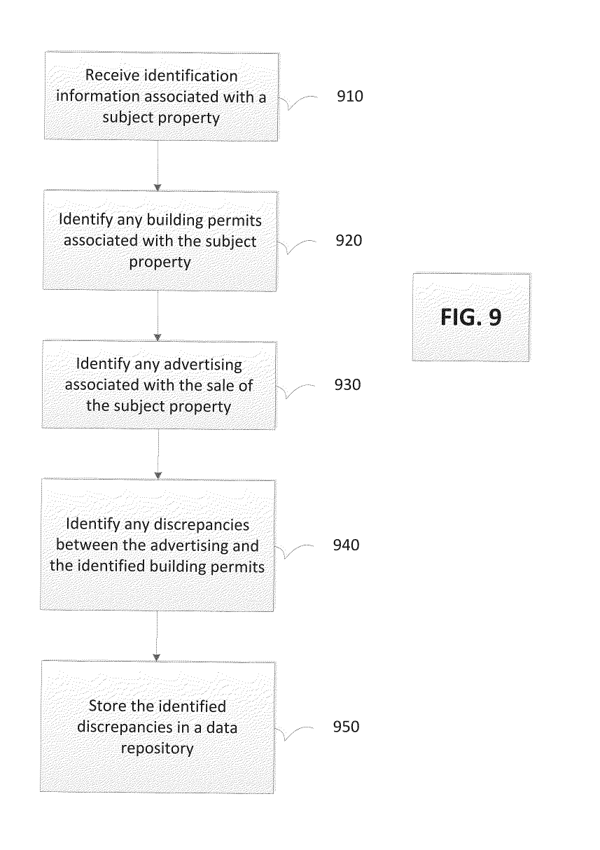

FIG. 9 illustrates one embodiment of an automated process that may be used by the analytics applications 22 to detect potential fraud based on the collected business permits data.

As depicted by block 910 of FIG. 9, the application 44 initially receives identification information associated with a subject property (e.g., address, property owner identification, parcel number, etc.). Application 44 may communicate with computing device 26 to receive the identification information. The application 44 may then, in some embodiments, process the received identification information to uniquely identify the subject property of interest by, for example, communicating with data repositories 30-36 or any other data repository to map the received identification information to the subject property.

As shown in block 920 of FIG. 9, any building permits associated with the subject property are identified. As discussed above, application 44 may communicate with application 42 to identify any collected business permits data associated with the subject property.

As depicted by block 930 of FIG. 9, any advertising associated with the identified subject property is identified. As discussed above, online data resources may be accessed to identify any advertising associated with the subject property.

Subsequently, as depicted by block 940 of FIG. 9, any discrepancies between the identified advertising and the collected business permits data associated with the subject property are identified. As discussed above, information associated with the advertising may be compared to the business permits data to identify any discrepancies.

As depicted by block 950 of FIG. 9, application 44 may store the identified discrepancies in a data repository. The discrepancies may be provided in one or more reports and/or provided to interested parties. In some embodiments, a risk or fraud score may be calculated as discussed above.

### Example Alternate Real Estate Fraud Detection Process

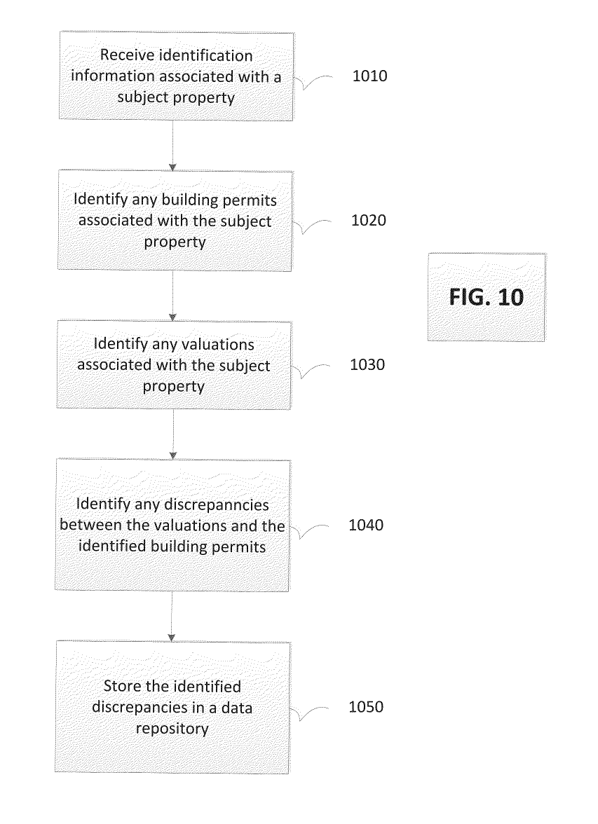

FIG. 10 illustrates one embodiment of an automated process that may be used by the analytics applications 22 to detect potential fraud based on the collected business permits data.

As depicted by block 1010 of FIG. 10, the application 44 initially receives identification information associated with a subject property (e.g., address, property owner identification, parcel number, etc.). Application 44 may communicate with computing device 26 to receive the identification information. The application 44 may then, in some embodiments, process the received identification information to uniquely identify the subject property of interest by, for example, communicating with data repositories 30-36 or any other data repository to map the received identification information to the subject property.

As shown in block 1020 of FIG. 10, any building permits associated with the subject property are identified. As discussed above, application 44 may communicate with application 42 to identify any collected business permits data associated with the subject property.

As depicted by block 1030 of FIG. 10, a valuation associated with the identified subject property is identified. As discussed above, any appraisals, BPOs, etc. may be identified. The valuations may under or overvalue the subject property.

Subsequently, as depicted by block 1040 of FIG. 10, any discrepancies between the identified valuations and the collected business permits data associated with the subject property are identified. As discussed above, information associated with the valuations, such as property information may be compared to the business permits data to identify any discrepancies.

As depicted by block 1050 of FIG. 10, application 44 may store the identified discrepancies in a data repository. The discrepancies may be provided in one or more reports and/or provided to interested parties. In some embodiments, a risk or fraud score may be calculated as discussed above.

### Example Real Estate Insurance Coverage Process

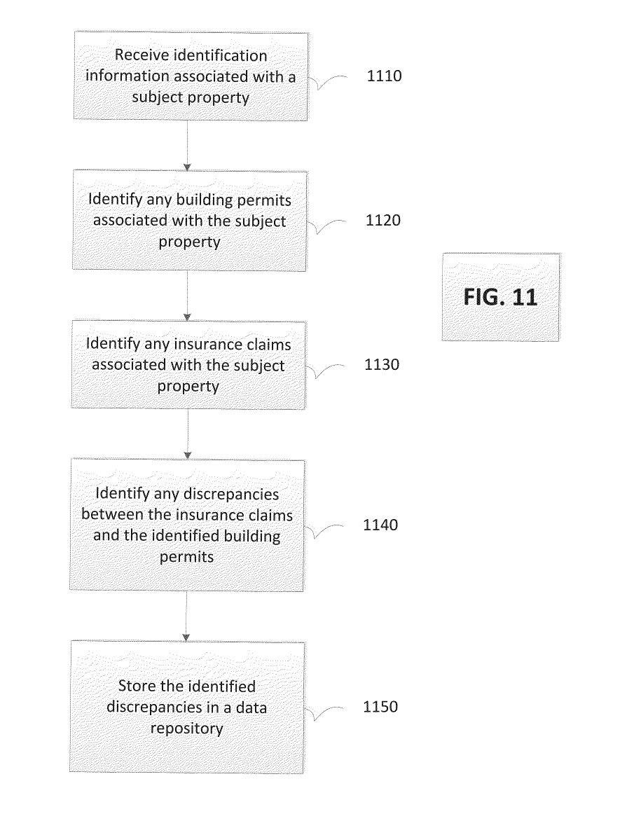

FIG. 11 illustrates one embodiment of an automated process that may be used by the analytics applications 22 to detect insurance coverage based on the collected business permits data.

As depicted by block 1110 of FIG. 11, the application 44 initially receives identification information associated with a subject property (e.g., address, property owner identification, parcel number, etc.). Application 44 may communicate with computing device 26 to receive the identification information. The application 44 may then, in some embodiments, process the received identification information to uniquely identify the subject property of interest by, for example, communicating with data repositories 30-36 or any other data repository to map the received identification information to the subject property.

As shown in block 1120 of FIG. 11, any building permits associated with the subject property are identified. As discussed above, application 44 may communicate with application 42 to identify any collected business permits data associated with the subject property.

As depicted by block 1130 of FIG. 11, any insurance claims associated with the identified subject property are identified. As discussed above, any pending or closed insurance claims related to the subject property are identified.

Subsequently, as depicted by block 1140 of FIG. 11, any discrepancies between the identified insurance claims and the collected business permits data associated with the subject property are identified. As discussed above, information associated with the insurance claims may be compared to the business permits data to identify any discrepancies to identify potential insurance claims for items not covered by the existing insurance policies.

As depicted by block 1150 of FIG. 11, application 44 may store the identified discrepancies in a data repository. The discrepancies may be provided in one or more reports and/or provided to interested parties. In some embodiments, a risk or fraud score may be calculated as discussed above.

### Example Real Estate Automated Valuation Process

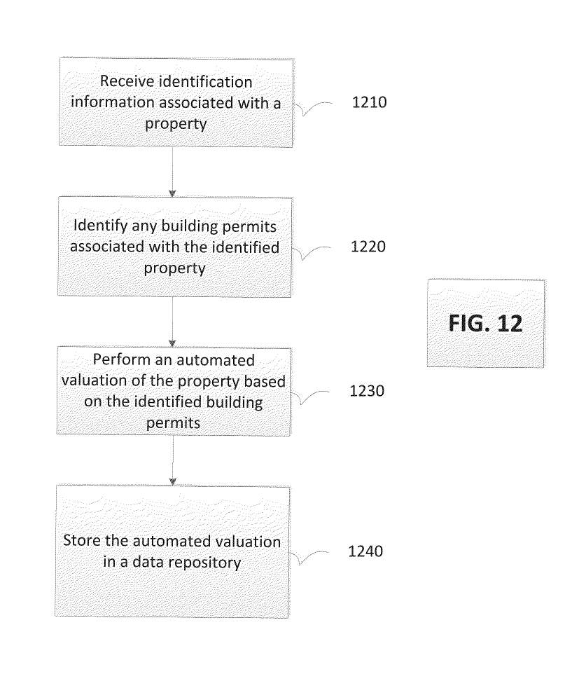

FIG. 12 illustrates one embodiment of an automated process that may be used by the analytics applications 22 to determine an automated valuation based on the collected business permits data.

As depicted by block 1210 of FIG. 12, the application 44 initially receives identification information associated with a subject property (e.g., address, property owner identification, parcel number, etc.). Application 44 may communicate with computing device 26 to receive the identification information. The application 44 may then, in some embodiments, process the received identification information to uniquely identify the subject property of interest by, for example, communicating with data repositories 30-36 or any other data repository to map the received identification information to the subject property.

As shown in block 1220 of FIG. 12, any building permits associated with the subject property are identified. As discussed above, application 44 may communicate with application 42 to identify any collected business permits data associated with the subject property.

As depicted by block 1230 of FIG. 12, an automated valuation is determined for the subject property based on the identified building permits data. As discussed above, in some embodiments, automated valuation models may be generated to determine the automated valuation.

Subsequently, as depicted by block 1240 of FIG. 12, application 44 may store the identified automated valuation in a data repository. The automated valuation may be provided in one or more reports and/or provided to interested parties.

### Example Real Estate Synchronization Process

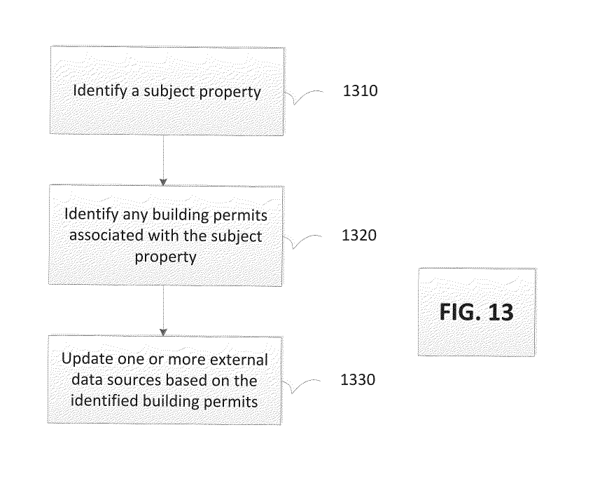

FIG. 13 illustrates one embodiment of an automated process that may be used by the analytics applications 22 to perform synchronization based on the collected business permits data.

As depicted by block 1310 of FIG. 13, the application 44 initially identifies a subject property (e.g., address, property owner identification, parcel number, etc.). Application 44 may communicate with data repositories 30-36 or any other data repository to identify the subject property.

As shown in block 1320 of FIG. 13, any building permits associated with the subject property are identified. As discussed above, application 44 may communicate with application 42 to identify any collected business permits data associated with the subject property.

As depicted by block 1330 of FIG. 13, one or more external data sources may be updated based on the identified building permits data. As discussed above, external systems including MLS systems and systems associated with Zillow, LPS, Redfin, Trulia, etc. may be updated to be synchronized with the identified building permits data.

### Example Real Estate Insurance Rating Process

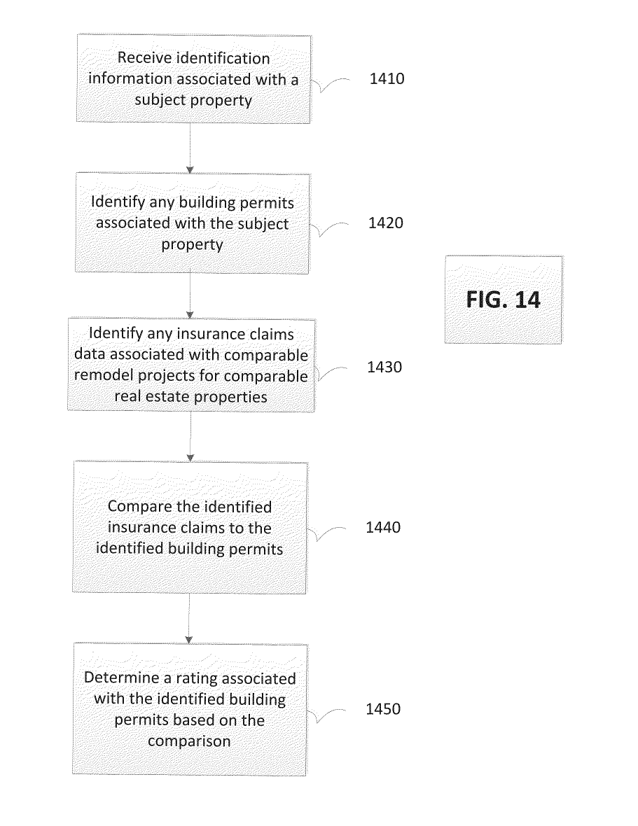

FIG. 14 illustrates one embodiment of an automated process that may be used by the analytics applications 22 to determine building permits ratings/rankings based on insurance data.

As depicted by block 1410 of FIG. 14, the application 44 initially receives identification information associated with a subject property (e.g., address, property owner identification, parcel number, etc.). Application 44 may communicate with computing device 26 to receive the identification information. The application 44 may then, in some embodiments, process the received identification information to uniquely identify the subject property of interest by, for example, communicating with data repositories 30-36 or any other data repository to map the received identification information to the subject property.

As shown in block 1420 of FIG. 14, any building permits associated with the subject property are identified. As discussed above, application 44 may communicate with application 42 to identify any collected business permits data associated with the subject property.

As depicted by block 1430 of FIG. 14, any insurance claims associated with comparable remodel projects for comparable real estate properties are identifies. As discussed above, the projects associated with the building permits are identified and comparable projects to the identified projects are determined. Collected insurance data for comparable properties and the comparable propjets are identified.

Subsequently, as depicted by block 1440 of FIG. 14, comparisons are made between the identified insurance claims and building permits. As discussed above, the insurance claims associated with comparable properties and projects can be used to identify the costs associated with those projects. Then the costs may be compared to the fees included in the identified building permits. The differences may be then used to determine the quality of a builder/contractor or to rate/rank a builder/contractor

As depicted by block 1450 of FIG. 14, application 44 may determine a rating/ranking associated with the identified building permits based on the comparison. Application 44 may determine the rating/ranking based on the comparison of the fees as discussed above. Application 44 may store or provide the ratings/rankings to interested parties, such as the computing device 26.

### Example Real Estate Profit Determination Process

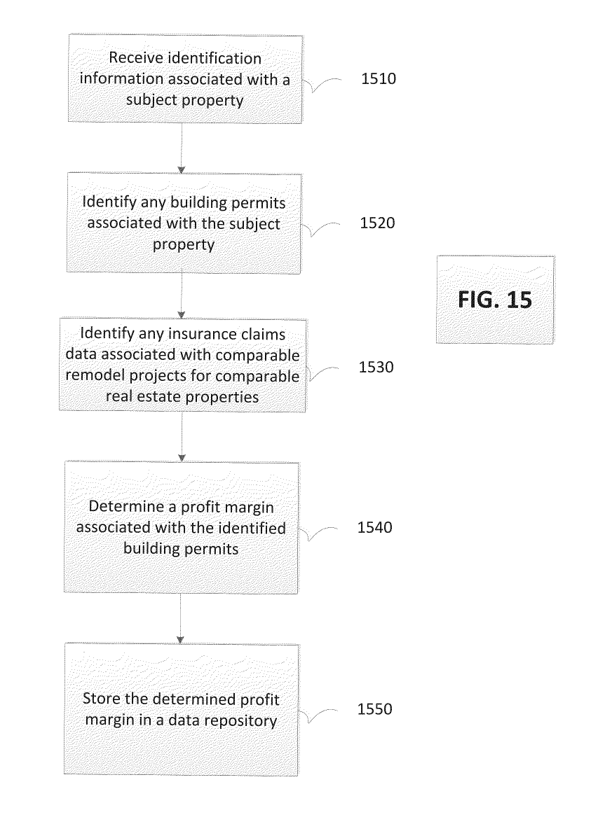

FIG. 15 illustrates one embodiment of an automated process that may be used by the analytics applications 22 to determine a profit index based on insurance and building permits data.

As depicted by block 1510 of FIG. 15, the application 44 initially receives identification information associated with a subject property (e.g., address, property owner identification, parcel number, etc.). Application 44 may communicate with computing device 26 to receive the identification information. The application 44 may then, in some embodiments, process the received identification information to uniquely identify the subject property of interest by, for example, communicating with data repositories 30-36 or any other data repository to map the received identification information to the subject property.

As shown in block 1520 of FIG. 15, any building permits associated with the subject property are identified. As discussed above, application 44 may communicate with application 42 to identify any collected business permits data associated with the subject property.

As depicted by block 1530 of FIG. 15, any insurance claims associated with comparable remodel projects for comparable real estate properties are identified. As discussed above, the projects associated with the building permits are identified and comparable projects to the identified projects are determined. Collected insurance data for comparable properties and the comparable propjets are identified.

Subsequently, as depicted by block 1540 of FIG. 15, a profit margin for the identified building permits is determined. A comparison of the fees from the insurance data with the fees for the building permits can be calculated. As discussed above, the fees from the insurance data may provide the costs for the remodeling projects associated with the building permits. Comparison of these fees with the fees included with the building permits can provide an estimate of the profits included with the building permits. Similar processing can be performed for other properties. In some embodiments, as discussed above, a profit index may be developed based on aggregated profits that are determined. The profit indexes in some embodiments may be used by predictive models to determine what fees may be charged for a particular project. In various embodiments, the profit index may also be used to rank/rate contractors by the amount of profit they include in the building permits.

As depicted by block 1550 of FIG. 15, application 44 may store the determined profit margin in a data repository. The profit margin may be provided in one or more reports and/or provided to interested parties.

### Example Market Statistics Process

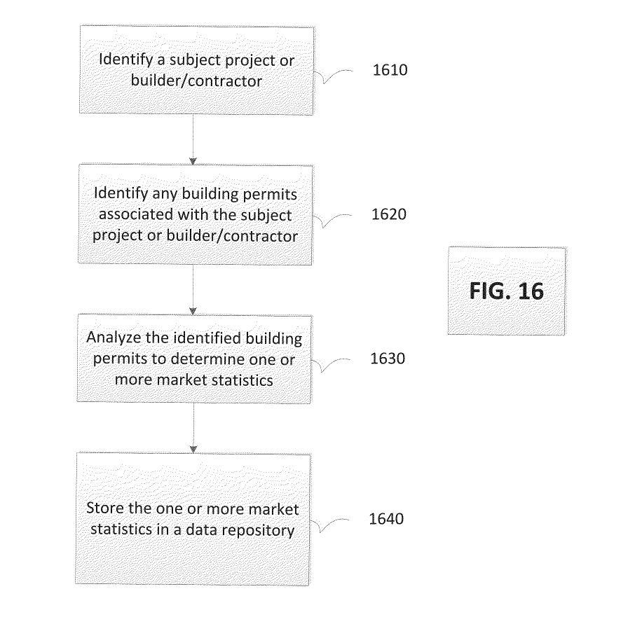

FIG. 16 illustrates one embodiment of an automated process that may be used by the analytics applications 22 to determine market statistics based on collected building permits data.

As depicted by block 1610 of FIG. 16, the application 44 initially identifies a subject project or builder/contractor. Application 44 may identify any project or builder/contractor for which business permits have been collected.

As shown in block 1620 of FIG. 16, any building permits associated with the subject project or builder/contractor are identified. As discussed above, application 44 may communicate with application 42 to identify any collected business permits data associated with the subject project or builder/contractor.

As depicted by block 1630 of FIG. 16, any identified building permits are analyzed to determine one or more market statistics. As discussed above, the market statistics may relate to market share, aggregate market trends, project comparisons, builder/contractor comparisons, etc.

Subsequently, as depicted by block 1640 of FIG. 16, application 44 may store the identified market statistics in a data repository. The identified market statistics may be provided to interest parties, such as vendors, builder/contractors, consumers, etc.

### Conclusion

All of the methods and tasks described herein may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium or device. The various functions disclosed herein may be embodied in such program instructions, although some or all of the disclosed functions may alternatively be implemented in application-specific circuitry (e.g., ASICs or FPGAs) of the computer system. Where the computer system includes multiple computing devices, these devices may, but need not, be co-located, and may be cloud-based devices that are assigned dynamically to particular tasks. The results of the disclosed methods and tasks may be persistently stored by transforming physical storage devices, such as solid state memory chips and/or magnetic disks, into a different state.

The methods and processes described above may be embodied in, and fully automated via, software code modules executed by one or more general purpose computers. The code modules, such as the scorecard module 301, sales leads module 302, fraud module 303, automated valuation module 304, synchronization module 305, insurance module 306, and statistics module 307, may be stored in any type of computer-readable medium or other computer storage device. Some or all of the methods may alternatively be embodied in specialized computer hardware. Code modules or any type of data may be stored on any type of non-transitory computer-readable medium, such as physical computer storage including hard drives, solid state memory, random access memory (RAM), read only memory (ROM), optical disc, volatile or non-volatile storage, combinations of the same and/or the like. The methods and modules (or data) may also be transmitted as generated data signals (e.g., as part of a carrier wave or other analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). The results of the disclosed methods may be stored in any type of non-transitory computer data repository, such as databases 30-36, relational databases and flat file systems that use magnetic disk storage and/or solid state RAM. Some or all of the components shown in FIG. 1, such as those that are part of the Analytics System, may be implemented in a cloud computing system.

Further, certain implementations of the functionality of the present disclosure are sufficiently mathematically, computationally, or technically complex that application-specific hardware or one or more physical computing devices (utilizing appropriate executable instructions) may be necessary to perform the functionality, for example, due to the volume or complexity of the calculations involved or to provide results substantially in real-time.

Any processes, blocks, states, steps, or functionalities in flow diagrams described herein and/or depicted in the attached figures should be understood as potentially representing code modules, segments, or portions of code which include one or more executable instructions for implementing specific functions (e.g., logical or arithmetical) or steps in the process. The various processes, blocks, states, steps, or functionalities can be combined, rearranged, added to, deleted from, modified, or otherwise changed from the illustrative examples provided herein. In some embodiments, additional or different computing systems or code modules may perform some or all of the functionalities described herein. The methods and processes described herein are also not limited to any particular sequence, and the blocks, steps, or states relating thereto can be performed in other sequences that are appropriate, for example, in serial, in parallel, or in some other manner. Tasks or events may be added to or removed from the disclosed example embodiments. Moreover, the separation of various system components in the implementations described herein is for illustrative purposes and should not be understood as requiring such separation in all implementations. It should be understood that the described program components, methods, and systems can generally be integrated together in a single computer product or packaged into multiple computer products. Many implementation variations are possible.

The processes, methods, and systems may be implemented in a network (or distributed) computing environment. Network environments include enterprise-wide computer networks, intranets, local area networks (LAN), wide area networks (WAN), personal area networks (PAN), cloud computing networks, crowd-sourced computing networks, the Internet, and the World Wide Web. The network may be a wired or a wireless network or any other type of communication network.

The various elements, features and processes described herein may be used independently of one another, or may be combined in various ways. All possible combinations and subcombinations are intended to fall within the scope of this disclosure. Further, nothing in the foregoing description is intended to imply that any particular feature, element, component, characteristic, step, module, method, process, task, or block is necessary or indispensable. The example systems and components described herein may be configured differently than described. For example, elements or components may be added to, removed from, or rearranged compared to the disclosed examples.

As used herein any reference to “one embodiment” or “some embodiments” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. In addition, the articles “a” and “an” as used in this application and the appended claims are to be construed to mean “one or more” or “at least one” unless specified otherwise.

As used herein, the terms “comprises,” “comprising,” “includes,” “including,” “has,” “having” or any other variation thereof, are open-ended terms and intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present). As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y and at least one of Z to each be present.

The foregoing disclosure, for purpose of explanation, has been described with reference to specific embodiments, applications, and use cases. However, the illustrative discussions herein are not intended to be exhaustive or to limit the inventions to the precise forms disclosed. Many modifications and variations are possible in view of the above teachings. The embodiments were chosen and described in order to explain the principles of the inventions and their practical applications, to thereby enable others skilled in the art to utilize the inventions and various embodiments with various modifications as are suited to the particular use contemplated.

What is claimed is:

1. A system comprising:
physical data storage configured to store building permits data; and
a computer system in communication with the physical data storage, the computer system comprising computer hardware, the computer system programed to:
receive, by the computer system over a network communication channel, identification information associated with a subject property;
identify, by the computer system, one or more building permits associated with the subject property from the physical data storage;
determine, by the computer system, an automated valuation for the subject property based at least in part on the one or more identified building permits; and
store the determined automated valuation in the physical data storage.

2. The system of claim 1, wherein the automated valuation is determined using an automated valuation model.

3. The system of claim 2, wherein the automated valuation model comprises a regression model.

4. The system of claim 2, wherein the automated valuation model comprises a neural network.

5. The system of claim 1, wherein the automated valuation comprises a neural network.

6. The system of claim 1, wherein the one or more identified building permits comprise a contractor, a cost, and a permit class.

7. The system of claim 1, wherein the building permits are converted to a standard format before storage in the physical data storage.

8. A non-transitory computer readable storage medium comprising instructions which, when executed by a computer system that includes a data processor and is connected to at least one data repository, perform a method comprising:
(a) receiving, by the computer system through a network communication channel, identification information associated with a property;
(b) accessing, by the computer system from the at least one data repository through a communication channel, building permits data associated with the property;
(c) checking, by the data processor of the computer system, a status associated with the accessed building permits data to identify any building permits associated with incomplete projects;
(d) determining, by the data processor of the computer system, a product or service associated with the identified building permits; and
(e) storing, by the data processor of the computer system through the communication channel, the determined product or service as a potential sales lead in the at least one data repository.

9. The non-transitory computer readable storage medium of claim 8, wherein the method further comprises identifying one or more supplementary products or services associated with the identified building permits and storing the one or more supplementary products or services as additional sales leads in the at least one data repository.

10. The non-transitory computer readable storage medium of claim 9, wherein the method further comprises providing the identified one or more supplementary products or services to one or more vendors for a fee.

11. The non-transitory computer readable storage medium of claim 8, wherein the method further comprises providing the determined product or service to one or more vendors for a fee.

12. The non-transitory computer readable storage medium of claim 11, wherein the one or more vendors are identified from a list of vendors in a region associated with the property that provide product or services comparable to the determined product or service associated with the identified building permits.

13. The non-transitory computer readable storage medium of claim 8, wherein the method further comprises filtering the accessed building permits data to access only recent building permits data prior to checking the status.

14. A non-transitory computer readable storage medium comprising instructions which, when executed by a computer system that includes a data processor and is connected to at least one data repository, perform a method comprising:
(a) receiving, by the computer system through a network communication channel, identification information associated with a property;
(b) accessing, by the computer system from the at least one data repository through a communication channel, building permits data associated with the property;
(c) identifying, by the computer system, property information associated with the property;
(d) identifying, by the computer system, one or more discrepancies between the identified property information and the accessed building permits data; and
(e) storing, by the data processor of the computer system through the communication channel, the identified one or more discrepancies in the at least one data repository.

15. The non-transitory computer readable storage medium of claim 14, wherein the property information comprises advertising associated with the property.

16. The non-transitory computer readable storage medium of claim 14, wherein the property information comprises a valuation associated with the property.

17. The non-transitory computer readable storage medium of claim 14, wherein the property information comprises a pending sales offer associated with the property.

18. The non-transitory computer readable storage medium of claim 14, wherein the property information comprises an insurance claim associated with the property.

19. The non-transitory computer readable storage medium of claim 14, wherein the method further comprises providing the one or more identified discrepancies to a financial institution.

20. The non-transitory computer readable storage medium of claim 14, wherein the one or more discrepancies comprise a discrepancy in property characteristics.
